(19) United States
(12) Patent Application Publication
(10) Pub. No.: US 2022/0348796 A1
(43) Pub. Date: Nov. 3, 2022

(54) OPTICAL ADHESIVE TAPE AND DISPLAY PANEL

(71) Applicant: KunShan Go-Visionox Opto-Electronics Co., Ltd., Kunshan (CN)

(72) Inventors: Yuchen TIAN, Kunshan (CN); Jiansong MI, Kunshan (CN)

(73) Assignee: KunShan Go-Visionox Opto-Electronics Co., Ltd., Kunshan (CN)

(21) Appl. No.: 17/867,096

(22) Filed: Jul. 18, 2022

Related U.S. Application Data
(63) Continuation of application No. PCT/CN2021/095634, filed on May 25, 2021.

(30) Foreign Application Priority Data
Jul. 24, 2020 (CN) 202010722550.X

(51) Int. Cl. C09J 7/29

(52) U.S. Cl. CPC C09J 7/29; C09J 2203/326; C09J 2301/16; C09J 2301/124; C09J 2400/243; C09J 2400/163; C09J 2400/123; C09J 2467/006; C09J 2479/086

(57) ABSTRACT

Disclosed by embodiments of the present application are an optical adhesive tape and a display panel. The optical adhesive tape includes a first buffer layer and an opening disposed at a position corresponding to the fingerprint identification area and configured to penetrate the first buffer layer. The opening is filled with a removable filler including a second buffer layer.

### CROSS-REFERENCE TO RELATED APPLICATIONS

The present application is a continuation of International Application No. PCT/CN2021/095634, filed on May 25, 2021, which claims priority to Chinese Patent Application No. 202010722550.X, filed on Jul. 24, 2020. All applications are incorporated herein by reference in their entireties.

### TECHNICAL FIELD

Embodiments of the present application relate to the field of display technologies, and in particular to an optical adhesive tape and a display panel.

### BACKGROUND

As for a flexible display panel, a fingerprint hole need to be opened on materials, such as a composite tape and a flexible circuit board, to fit a fingerprint module to realize fingerprint on display (FOD). At the fingerprint hole, due to a difference of film materials, uneven colors, phenomena such as uneven depths of colors and obvious boundaries may appear under an influence of external pressure or light and temperature, resulting in poor product display.

### SUMMARY

In view of this, embodiments of the present application are committed to providing an optical adhesive tape and a display panel using the optical adhesive tape so as to solve problems such as uneven colors, uneven depths of colors and obvious boundaries in a process of preparing a fingerprint hole.

According to an aspect of the present application, an optical adhesive tape provided by an embodiment of the present application is used in a fingerprint identification area. The optical adhesive tape includes: a first buffer layer and an opening disposed at a position corresponding to the fingerprint identification area and configured to penetrate the first buffer layer. The opening is filled with a removable filler including a second buffer layer.

According to another aspect of the present application, a display panel provided by an embodiment of the present application includes: an array substrate and an optical adhesive tape. Pixel units are disposed on a side of the array substrate. The optical adhesive tape is disposed on a side of the array substrate away from the pixel units. The optical adhesive tape includes the optical adhesive tape described in any one of the above embodiments.

The optical adhesive tape and the display panel are provided by the embodiments of the present application. The opening is disposed at the position of the optical adhesive tape corresponding to the fingerprint identification area and configured to penetrate the first buffer layer of the optical adhesive tape. In addition, the opening is filled with the removable filler including the second buffer layer. Therefore, by using the second buffer layer, a condition of a same pressure, light and temperature may have a same or similar effect on the opening and other positions of the optical adhesive tape during a preparation process. In this way, phenomena such as uneven colors, uneven depths of colors and obvious boundaries in the fingerprint identification area corresponding to the opening are avoided, a passed yield of a product is improved, and the filler in the opening is peeled off after the preparation process is completed to ensure a function of recording a fingerprint of the fingerprint hole.

### BRIEF DESCRIPTION OF DRAWINGS

FIG. 1 shows a schematic structural diagram of an optical adhesive tape according to an embodiment of the present application. Specifically, an opening of the optical adhesive tape is filled with a second buffer layer, a second heat dissipation layer and a second adhesive layer.

FIG. 2 shows a schematic structural diagram of an optical adhesive tape according to another embodiment of the present application. Specifically, only a second buffer layer and a second adhesive layer are filled in an opening of the optical adhesive tape.

FIG. 3 shows a flow diagram of a preparation method of optical adhesive tape according to an embodiment of the present application.

### DETAILED DESCRIPTION OF THE EMBODIMENTS

Technical solutions in embodiments of the present application will be clearly and completely described below with reference to accompanying drawings in the embodiments of the present application. Obviously, the embodiments described below are only a part, but not all, of the embodiments of the present application. Based on the embodiments of the present application, all other embodiments, obtained by those skilled in the art without creative efforts, may fall within the protection scope of the present application.

As is well known, a mask plate includes an opening area and a shielding area adjacent to the opening area. In an actual preparation process of the mask plate, a mesh surface of the mask plate usually need to be welded to a frame of the mask plate according to a position of a predetermined welding line. After the mesh surface has welded to the frame, a buffer area is cut off along a predetermined distance from a periphery of an edge of the welding line.

Further, in the exemplary embodiments, same reference marks denote same components having a same structure, or same steps of a same method. If an embodiment is exemplarily described, only a structure or a method different from the described embodiment are described in other exemplary embodiments.

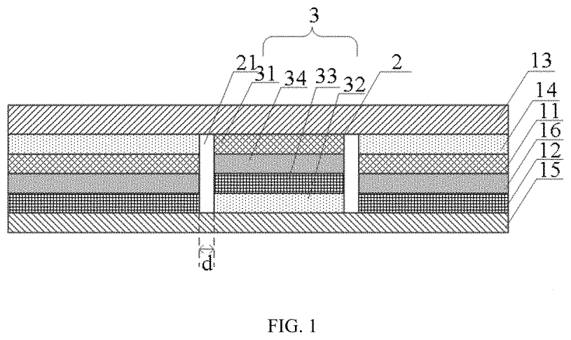

FIG. 1 shows a schematic structural diagram of an optical adhesive tape according to an embodiment of the present application. Specifically, an opening of the optical adhesive tape is filled with a second buffer layer, a second heat dissipation layer and a second adhesive layer. As shown in FIG. 1, the optical adhesive tape is used in a fingerprint identification area. The optical adhesive tape includes a first buffer layer 11 and an opening 2. The opening 2 is disposed at a position corresponding to the fingerprint identification area and configured to penetrate the first buffer layer 11. The opening 2 is filled with a removable filler 3 including a second buffer layer 31. In a display panel, a film layer for buffering external stress may be usually disposed on a non-luminous side of an array substrate layer, and the film layer for buffering external stress is usually made of the optical adhesive tape. Therefore, by stacking a material with a function of buffering external stress and materials with other functions to form a combined film layer, the function of buffering external stress may be realized by the combined film layer. In addition, other required functions may also be realized by the materials with other functions in the combined film layer. For example, a heat conduction function can be realized by setting a material, or a film layer, with a heat conduction performance. With continuous development of the fingerprint identification technology, more and more display panels, such as mobile phones, are equipped with fingerprint identification structures. In order to realize fingerprint identification, a fingerprint hole needs to be reserved on the display panel to record a fingerprint of a user. A shape of the fingerprint hole may be round, square or oval. In order to maximize a display screen, at present, under screen fingerprint identification is adopted by more and more display panels. That is, the fingerprint hole is set on a non-luminous side of the display panel to avoid the fingerprint hole occupying an area of the screen. As for the display panel using the optical adhesive tape as a buffer film layer, a through hole need to be set at a position of the optical adhesive tape corresponding to the fingerprint hole, so as to ensure that light corresponding to a finger of the user may reach a fingerprint recording module through the through hole to realize the fingerprint identification. However, as for the optical adhesive tape with the opening, during a preparation process of a display module, there are no other film layers to be disposed at the opening of the optical adhesive tape, and materials of the other film layers are disposed at other positions of the optical adhesive tape, and the materials of the other film layers have different reactions on pressure, light and temperature. That is, during the preparation process, a property presented by a position of the opening of the optical adhesive tape is different from a property presented by the other positions of the optical adhesive tape. As a result, after the display panel is prepared, a color brightness or depth of the position of the opening is not uniform with a color brightness or depth of the other positions in the optical adhesive tape, and even an obvious boundary may appear at an edge of the opening, eventually, resulting in improving a defective rate of a product.

In order to solve the above problems, a structure of the optical adhesive tape is provided by the embodiment of the present application. The optical adhesive tape includes the first buffer layer 11. By using the first buffer layer 11, a function of absorbing and alleviating the external stress may be realized by the optical adhesive tape. The opening 2 is disposed at the position of the optical adhesive tape corresponding to the fingerprint identification area and configured to penetrate the first buffer layer 11. A function of fingerprint identification may be realized by using the opening 2. In addition, the opening 2 is filled with a removable filler 3 including the second buffer layer 31. A material of the second buffer layer 31 may be the same or similar to a material of the first buffer layer 11. By using the filler 3, a condition of a same pressure, light and temperature may have a same or similar effect on the opening 2 and the other positions of the optical adhesive tape. As a result, different display effects, caused by different conditions in the preparation process, at the opening 2 and the other positions of the optical adhesive tape may be avoided (that is, uneven colors, uneven depths of colors and obvious boundaries may appear).

In an embodiment, the first buffer layer 11 may include foam. By using foam, the external stress may be absorbed and alleviated, so as to reduce an influence of the external stress on an array substrate. In an embodiment, the second buffer layer 31 includes a flexible material such as polyethylene glycol terephthalate or foam. By using the flexible material such as polyethylene glycol terephthalate or foam, the condition of the same pressure, light and temperature may have the same effect on the opening 2 and the other positions of the optical adhesive tape. In the embodiments of the present application, the specific materials of the first buffer layer 11 and the second buffer layer 31 may be selected according to a requirement of an actual application scenario. For example, the second buffer layer 31 may also include black polyimide (PI) or other opaque materials. As long as the materials of the first buffer layer 11 and the second buffer layer 31 are the same or similar and have the function of alleviating the external stress, the specific materials of the first buffer layer 11 and the second buffer layer 31 are not limited by the embodiments of the present application.

In the optical adhesive tape provided by the embodiments of the present application, the opening is disposed at the position of the optical adhesive tape corresponding to the fingerprint identification area and configured to penetrate the first buffer layer of the optical adhesive tape. In addition, the opening is filled with the removable filler including the second buffer layer. Therefore, by using the second buffer layer, the condition of the same pressure, light and temperature may have the same or similar effect on the opening and the other positions of the optical adhesive tape during the preparation process. In this way, phenomena such as uneven colors, uneven depths of colors and obvious boundaries in the fingerprint identification area corresponding to the opening are avoided, a passed yield of a product is improved, and the filler in the opening is peeled off after the preparation process is completed to ensure a function of recording a fingerprint of the fingerprint hole.

In an embodiment, as shown in FIG. 1, the optical adhesive tape may include a first heat dissipation layer 12 stacked with the first buffer layer 11. A heat dissipation function of the optical adhesive tape to the array substrate may be realized by using the first heat dissipation layer 12.

In an embodiment, the first heat dissipation layer 12 may include a material with a good thermal conductivity. For example, the first heat dissipation layer 12 may include copper foil. By using copper foil, not only functions of heat conduction and heat dissipation to the array substrate may be realized, but also a rigidity characteristic of copper foil can be used to provide a certain supporting effect for the array substrate. In the embodiments of the present application, a specific material of the first heat dissipation layer 12 may be selected according to a requirement of an actual application scenario, as long as the heat conduction function of the first heat dissipation layer 12 is ensured. The specific material of the first heat dissipation layer 12 is not limited by the embodiments of the present application.

In an embodiment, as shown in FIG. 1, there is a gap 21 between the filler 3 and an inner wall of the opening 2. By disposing the gap 21 between the filler 3 and the inner wall of the opening 2, a subsequent difficulty of peeling off the filler 3, caused by the opening 2 that is overfilled by the filler 3, may be avoided. Meanwhile, display consistency between the opening 2 and the other positions of the optical adhesive tape may be ensured, and convenience of subsequently peeling off the filler 3 may be ensured to prevent additional difficulty in the preparation.

In an embodiment, as shown in FIG. 1, a width of the gap 21 may range from 0.1 mm to 0.2 mm. By disposing the gap 21 with the certain width, the filler 3 may be easily peeled off from the opening 2 in a later stage, thereby reducing the difficulty in the preparation. In the embodiments of the present application, the specific width of the gap 21 may be selected according to a requirement of an actual application scenario, as long as the filler 3 may be easily peeled off by using the selected width of the gap 21. The specific width of the gap 21 is not limited by the embodiments of the present application.

In an embodiment, as shown in FIG. 1, the optical adhesive tape may also include a release film 13. The release film 13 is disposed on a side of the first buffer layer 11 away from the first heat dissipation layer 12. The release film 13 is configured to cover the filler 3. The release film 13 refers to a film that may be peeled off from a surface. The release film 13 fails to be sticky, or changes to be slightly sticky, after the release film 13 contacts with a specific material under a limited condition. Main functions of the release film 13 include isolation, filling, protection and easy peeling. By disposing the release film 13, the optical adhesive tape may be isolated from the outside. In addition, when the optical adhesive tape needs to be bonded with the array substrate, the optical adhesive tape may be directly bonded with the array substrate only after the release film 13 is peeled off, so as to simplify an operation.

In an embodiment, as shown in FIG. 1, the optical adhesive tape may also include a first adhesive layer 14 disposed between the release film 13 and the first buffer layer 11. By disposing the first adhesive layer 14, the optical adhesive tape may be bonded with the array substrate by using the first adhesive layer 14. In addition, the optical adhesive tape may be isolated and protected by using the release film 13 before the optical adhesive tape has been bonded with the array substrate.

In an embodiment, the first adhesive layer 14 may include double-sided adhesive, such as optical adhesive, etc. In the embodiments of the present application, a specific material of the first adhesive layer 14, such as optical adhesive and water adhesive, may be selected according to a requirement of an actual application scenario. As long as the optical adhesive tape may be bonded with the array substrate by using the first adhesive layer 14, the specific material of the first adhesive layer 14 is not limited by the embodiments of the present application.

In an embodiment, as shown in FIG. 1, the optical adhesive tape may also include a protective film 15 disposed on a side of the first heat dissipation layer 12 away from the first buffer layer 11. The protective film 15 is configured to cover the filler 3. By disposing the protective film 15, other film layers of the optical adhesive tape and the filler 3 may be protected by the protective film 15.

In an embodiment, as shown in FIG. 1, the optical adhesive tape may also include a first heat conduction layer 16 disposed between the first buffer layer 11 and the first heat dissipation layer 12. In a further embodiment, the first heat conduction layer 16 may include a PI layer or a graphite layer. When the optical adhesive tape is bonded to the array substrate, the first buffer layer 11 is close to the array substrate. Therefore, by disposing the PI layer or the graphite layer, heat of the array substrate and the first buffer layer 11 may be transferred to the first heat dissipation layer 12 via the first heat conduction layer 16 by using the first heat dissipation layer 12 and a thermal conductivity of graphite, thereby further improving a heat dissipation effect. An indentation produced during a module bonding process and other defects may be improved by using flexibility of PI (polyimide). Moreover, since the graphite layer is usually a lamellar structure, a phenomena such as delamination and chipping may appear. Therefore, the PI layer is used to wrap graphite to avoid a problem of delamination and chipping of graphite after a reliability test. In the embodiments of the present application, whether other film layers are set between the first buffer layer 11 and the first heat dissipation layer 12, and a specific material of the other film layers, may be selected according to a requirement of an actual application scenario. For example, the other film layers fail to be disposed between the first buffer layer 11 and the first heat dissipation layer 12. That is, the first buffer layer 11 directly contacts with the first heat dissipation layer 12, and a rapid heat transfer may also be realized. As long as the selected film layers between the first buffer layer 11 and the first heat dissipation layer 12 may meet a heat dissipation requirement, the specific film layers between the first buffer layer 11 and the first heat dissipation layer 12 and the specific material of the specific film layers are not limited by the embodiments of the present application.

In an embodiment, as shown in FIG. 1, the filler 3 may include a second adhesive layer 32 disposed between the second buffer layer 31 and the protective film 15. By directly disposing the second adhesive layer 32 between the second buffer layer 31 and the protective film 15, after the optical adhesive tape being bonded with the array substrate is completed, the filler 3 adhered to the protective film 15 may be jointly peeled off by peeling off the protective film 15, so as to simply peel off the filler 3 and realize a preparation of the fingerprint hole. In the embodiments of the present application, a specific material of the second adhesive layer 32, such as optical glue and water glue, may be selected according to a requirement of an actual application scenario. As long as the second adhesive layer 32 may ensure that the filler 3 can be jointly peeled off when the protective film 15 is peeled off, the specific material of the second adhesive layer 32 is not limited by the embodiments of the present application.

In an embodiment, as shown in FIG. 1, the filler 3 may include a second heat dissipation layer 33 disposed between the second buffer layer 31 and the second adhesive layer 32. By disposing the second heat dissipation layer 33, effects of a same temperature on the opening 2 and the other positions of the optical adhesive tape may be ensured to be the same during the preparation process. In an embodiment, the second heat dissipation layer 33 may include the material with the good thermal conductivity. For example, the second heat dissipation layer 33 may be copper foil, etc. By using copper foil, not only functions of heat conduction and heat dissipation to the opening 2 may be realized during the preparation process, but also the rigidity characteristic of copper foil can be used to provide a certain supporting effect for the opening 2. In the embodiments of the present application, a specific material of the second heat dissipation layer 33 may be selected according to a requirement of an actual application scenario. As long as a heat conduction to function of the second heat dissipation layer 33 may be ensured by using the selected material of the second heat dissipation layer 33, the specific material of the second heat dissipation layer 33 is not limited by the embodiments of the present application.

In an embodiment, as shown in FIG. 1, the filler 3 may also include a second heat conduction layer 34. In a further embodiment, the second heat conduction layer 34 may include a PI layer or a graphite layer. By disposing the PI layer or the graphite layer, a structure of the filler 3 at the opening 2 may be consistent with a film structure of the other positions of the optical adhesive tape, so as to ensure that during the preparation process, influences of pressure, light and temperature on the opening 2 and the other positions of the optical adhesive tape are consistent. In the embodiments of the present application, whether to set the second heat conduction layer 34 may be selected according to a requirement of an actual application scenario, as long as during the preparation process, the influences of pressure, light and temperature on the opening 2 and the other positions of the optical adhesive tape are consistent. Whether to set the second heat conduction layer 34 is not limited by the embodiments of the present application.

In an embodiment, as shown in FIG. 1, the optical adhesive tape can include the release film 13, the first adhesive layer 14, the first buffer layer 11, the first heat dissipation layer 12 and the protective film 15 successively stacked along a direction from a side close to the array substrate to a side away from the array substrate. Correspondingly, the filler 3 may include the second buffer layer 31, the second heat dissipation layer 33 and the second adhesive layer 32 successively stacked along the direction from the side close to the array substrate to the side away from the array substrate. By disposing film layers disposed in the filler 3 to be the same or similar to film layers disposed in the other positions of the optical adhesive tape, and only a stacking sequence of the film layers disposed in the filler 3 being different from a stacking sequence of the film layers disposed in the other positions, a display effect of the opening 2 may be ensured to be consistent with a display effect of the other positions of the optical adhesive tape under the condition of the same pressure, light and temperature, so as to avoid the phenomena of uneven colors, uneven depths of colors and obvious boundaries. In another embodiment, as shown in FIG. 1, the first heat conduction layer 16 may be disposed between the first buffer layer 11 and the first heat dissipation layer 12. Correspondingly, a second heat conduction layer 34 may be disposed between the second buffer layer 31 and the second heat dissipation layer 33 of the filler 3.

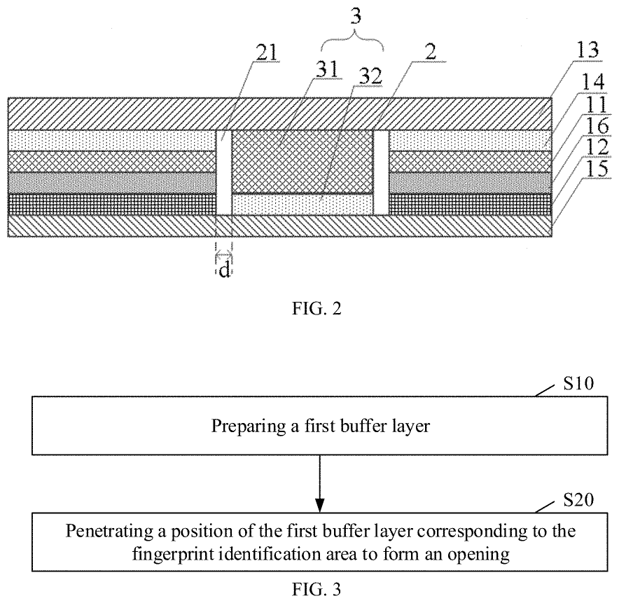

FIG. 2 shows a schematic structural diagram of an optical adhesive tape according to another embodiment of the present application. Specifically, only a second buffer layer and a second adhesive layer are filled in an opening. As shown in FIG. 2, the optical adhesive tape includes a first buffer layer 11. An opening 2 is disposed at a position, of the optical adhesive tape, corresponding to a fingerprint identification area, and the opening 2 is configured to penetrate the first buffer layer 11. The opening 2 is filled with a removable filler 3 including a second buffer layer 31. In a further embodiment, the optical adhesive tape may also include any one or more combinations of a release film 13, a first heat dissipation layer 12, a first adhesive layer 14, a protective film 15 and a first heat conduction layer 16 mentioned in the above embodiments. The filler may also include a second adhesive layer 32 disposed between the second buffer layer 31 and the protective film 15. In the embodiments of the present application, by filling only the second buffer layer 31 and the second adhesive layer 32, configured to stick the second buffer layer 31 and the protective film 15, in the opening 2, a display effect of the opening 2 may be ensured to be consistent with a display effect of other positions of the optical adhesive tape under a condition of a same pressure, light and temperature conditions, so as to avoid phenomena of uneven colors, uneven depths of colors and obvious boundaries. In addition, the filler 3 may be peeled off by peeling off the protective film 15.

A display panel is also provided by an embodiment of the present application. The display panel includes an array substrate and an optical adhesive tape. Pixel units are disposed on a side of the array substrate, and the optical adhesive tape is disposed on a side of the array substrate away from the pixel units. The optical adhesive tape includes the optical adhesive tape described in any one of the above-mentioned embodiments. In the display panel provided by the embodiments of the present applications, the opening is disposed at a position of the optical adhesive tape corresponding to a fingerprint identification area and configured to penetrate a first buffer layer of the optical adhesive tape. In addition, the opening is filled with a removable filler including a second buffer layer. Therefore, by using the second buffer layer, a condition of a same pressure, light and temperature may have a same or similar effect on the opening and other positions of the optical adhesive tape during a preparation process. In this way, phenomena such as uneven colors, uneven depths of colors and obvious boundaries in the fingerprint identification area corresponding to the opening are avoided, a passed yield of a product is improved, and the filler in the opening is peeled off after the preparation process is completed to ensure a function of recording a fingerprint of the fingerprint hole.

FIG. 3 shows a flow diagram of a preparation method of optical adhesive tape according to an embodiment of the present application. As shown in FIG. 3, the preparation method of optical adhesive tape provided by the embodiments of the present application is used for preparing the optical adhesive tape used in a fingerprint identification area. The method includes the following steps.

Step S10: preparing a first buffer layer.

Step S20: penetrating a position of the first buffer layer corresponding to the fingerprint identification area to form an opening.

The opening is filled with a removable filler including a second buffer layer.

In a process of practical application, firstly the first buffer layer is prepared, and then the opening configured to penetrate the first buffer layer is prepared at the position corresponding to the fingerprint identification area.

In the preparation method of optical adhesive tape provided by the embodiments of the present application, the opening is disposed at the position of the optical adhesive tape corresponding to the fingerprint identification area and configured to penetrate the first buffer layer of the optical adhesive tape. In addition, the opening is filled with the removable filler including the second buffer layer. Therefore, by using the second buffer layer, a condition of a same pressure, light and temperature may have a same or similar effect on the opening and other positions of the optical adhesive tape during a preparation process. In this way, phenomena such as uneven colors, uneven depths of colors and obvious boundaries in the fingerprint identification area corresponding to the opening are avoided. Therefore, compared with a preparation method of optical adhesive tape in the prior art, the preparation method of optical adhesive tape provided in the embodiments of the application may improve a passed yield of a product, and ensure a function of recording a fingerprint of the fingerprint hole.

The above are only preferred embodiments of the present application and are not used to limit the present application. Any modification, equivalent replacement, etc. made within the spirit and principle of the present application shall be included in the protection scope of the present application.

What is claimed is:

1. An optical adhesive tape, used in a fingerprint identification area, comprising:
a first buffer layer; and
an opening disposed at a position corresponding to the fingerprint identification area and configured to penetrate the first buffer layer,
wherein the opening is filled with a removable filler comprising a second buffer layer.

2. The optical adhesive tape of claim 1, wherein there is a gap between the filler and an inner wall of the opening.

3. The optical adhesive tape of claim 2, wherein a width of the gap ranges from 0.1 mm to 0.2 mm.

4. The optical adhesive tape of claim 1, wherein a material of the second buffer layer is the same as a material of the first buffer layer.

5. The optical adhesive tape of claim 1, wherein the first buffer layer comprises foam, and the second buffer layer comprises polyethylene glycol terephthalate or foam.

6. The optical adhesive tape of claim 1, wherein the optical adhesive tape further comprises a first heat dissipation layer stacked with the first buffer layer.

7. The optical adhesive tape of claim 6, wherein the first heat dissipation layer comprises copper foil.

8. The optical adhesive tape of claim 6, further comprising a release film, wherein the release film is disposed on a side of the first buffer layer away from the first heat dissipation layer and configured to cover the filler.

9. The optical adhesive tape of claim 8, further comprising a first adhesive layer disposed between the release film and the first buffer layer.

10. The optical adhesive tape of claim 9, wherein the first adhesive layer comprises double-sided adhesive.

11. The optical adhesive tape of claim 6, further comprising a protective film, wherein the protective film is disposed on a side of the first heat dissipation layer away from the first buffer layer and configured to cover the filler.

12. The optical adhesive tape of claim 6, further comprising a first heat conduction layer disposed between the first buffer layer and the first heat dissipation layer.

13. The optical adhesive tape of claim 12, wherein the first heat conduction layer comprises a Polyimide (PI) layer or a graphite layer.

14. The optical adhesive tape of claim 11, wherein the filler comprises a second adhesive layer disposed between the second buffer layer and the protective film.

15. The optical adhesive tape of claim 14, wherein the filler comprises a second heat dissipation layer disposed between the second buffer layer and the second adhesive layer.

16. The optical adhesive tape of claim 15, wherein the second heat dissipation layer comprises copper foil.

17. The optical adhesive tape of claim 1, wherein the filler further comprises a second heat conduction layer.

18. The optical adhesive tape of claim 17, wherein the second heat conduction layer comprises a Polyimide (PI) layer or a graphite layer.

19. A display panel, comprising:
an array substrate, wherein pixel units are disposed on a side of the array substrate; and
the optical adhesive tape according to claim 1 and disposed on a side of the array substrate away from the pixel units.
